(19) United States
(12) Patent Application Publication
(10) Pub. No.: US 2005/0284656 A1
(43) Pub. Date: Dec. 29, 2005

(54) Method for manufacturing printed circuit board and printed circuit board with gas venting hole

(75) Inventors: Chikara Shimada, Takefu-city (JP); Satoshi Torii, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/157,827

(22) Filed: Jun. 22, 2005

(30) Foreign Application Priority Data
Jun. 23, 2004 (JP) 2004-185416

(51) Int. Cl. B23K 31/00

(52) U.S. Cl. 174/255; 228/180.1

(57) ABSTRACT

The invention provides a printed circuit board to be subjected to dip soldering process using a dip soldering jig, the board capable of discharging gases generated by the volatilization of flux thereby preventing solder defects, and a method for manufacturing the printed circuit board. Gas venting holes 12 are formed in areas adjacent to lead wire welding components 11 on the forward side of the feeding direction of the printed circuit board in the dip soldering process (board feeding direction 13) and within the area of an opening 23 formed to the dip soldering jig 20. Thereby, gases generated during the dip soldering process are discharged efficiently.

The present application is based on and claims priority of Japanese patent application No. 2004-185416 filed on Jun. 23, 2004, the entire contents of which are hereby incorporated by reference.

### BACKGROUND OF THE INVENTION

1. Field of the Invention

The present invention relates to a printed circuit board on which electronic components are mounted, and especially, to a printed circuit board having electronic components soldered thereto via dip soldering, and the method for manufacturing the same.

2. Description of the Related Art

A printed circuit board is formed by applying a conductive pattern formed by beaten copper onto an insulating plate, and electrically connecting various electric/electronic components to the conductive pattern. Usually, the electric connection between the conductive pattern and the electric/electronic components is realized via soldering, and one example of such soldering method is dip soldering.

In dip soldering, a flux is applied to the surface of the printed circuit board to be subjected to soldering in order to facilitate the soldering process, but when the flux is volatilized by the heat of the pre-heater and the molten solder, gas is generated which may cause solder defects.

Japanese Patent Application Laid-Open Publications Nos. H06-120649 (patent document 1) and H09-148705 (patent document 2) disclose techniques which aim at preventing solder defects caused by the gas generated during volatilization of flux from occurring.

According to the dip soldering method, molten solder is applied to the surface of the printed circuit board subjected to soldering. Therefore, in order to prevent molten solder from contacting the areas other than necessary of the printed circuit board having components mounted on both sides thereof, the soldering process is carried out using a jig having an opening for exposing only the necessary areas of the printed circuit board. The printed circuit board is set to the dip soldering jig, and the dip soldering jig is fed over a solder jet stream from a solder bath to carry out soldering to the area exposed through the opening of the dip soldering jig. Further, when the printed circuit board (dip soldering jig) is fed to the solder bath during the dip soldering process, the substrate being transferred is tilted with respect to the horizontal plane (with the front side of the board toward the feeding direction raised) so as to prevent excessive solder from being applied and to carry out proper soldering.

According to the prior art disclosed in patent document 1, a gas venting hole is formed to a front end of a pilot pattern (wiring pattern) extended from a land portion to which a lead of an electronic component mounted on a printed circuit board is soldered via dip soldering, so as to prevent solder defects. However, if a dip soldering jig as mentioned above is used, the gas venting hole is covered by such jig.

### SUMMARY OF THE INVENTION

The present invention aims at providing a printed circuit board in which a dip soldering process is carried out using a dip soldering jig, characterized in that the gas generated by the volatilization of the flux can be effectively discharged so as to prevent solder defects.

A first aspect of the present invention relates to a method for manufacturing a printed circuit board having a conductive pattern formed on an insulating board and an electronic component connected electrically to the conductive pattern via dip soldering, the dip soldering performed using a dip soldering jig having an opening formed to expose only an area of the printed circuit board to be subjected to dip soldering, the method comprising at least a process for forming a gas venting hole to a portion on the printed circuit board in the area corresponding to the opening when the printed circuit board is attached to the dip soldering jig, prior to the dip soldering process.

According to this arrangement, dip soldering is performed after forming a gas venting hole to a portion of the printed circuit board in the area corresponding to the opening formed to the dip soldering jig when the printed circuit board is attached to the dip soldering jig.

A second aspect of the present invention relates to the method for manufacturing a printed circuit board according to the first aspect, wherein during the process for forming a gas venting hole to the printed circuit board, the gas venting hole is formed in an area adjacent to an electronic component subjected to dip soldering and on a side of the electronic component toward which the printed circuit board is fed in the dip soldering process, and wherein during the dip soldering process, the printed circuit board is fed in the feeding direction.

According to this arrangement, when the printed circuit board being fed is tilted to have its front end raised with respect to the horizontal plane in the dip soldering process, the dip soldering is conducted with the gas venting holes arranged on the front side of the electronic components (that is, at a position higher than the electronic components) subjected to dip soldering.

A third aspect of the present invention relates to a printed circuit board with a gas venting hole having a conductive pattern formed on an insulating board and an electronic component connected electrically to the conductive pattern via dip soldering, the dip soldering performed using a dip soldering jig having an opening formed to expose only an area of the printed circuit board to be subjected to dip soldering, the printed circuit board comprising a gas venting hole formed to a portion on the printed circuit board in the area corresponding to the opening when the printed circuit board is attached to the dip soldering jig.

The fourth aspect of the present invention relates to the printed circuit board with a gas venting hole according to the third aspect, wherein the gas venting hole is formed in an area adjacent to an electronic component subjected to dip soldering on a side of the electronic component toward which the printed circuit board is fed during the dip soldering process.

The fifth aspect of the present invention relates to the printed circuit board with a gas venting hole according to the third and fourth aspects, wherein the diameter of the gas venting hole is within the range of 0.8 mm through 3.0 mm.

The sixth aspect of the present invention relates to the printed circuit board with a gas venting hole according to the fifth aspect, wherein the diameter of the gas venting hole is within the range of 1.0 mm through 2.0 mm.

According to the first aspect of the present invention related to a method for manufacturing a printed circuit board having a conductive pattern formed on an insulating board and an electronic component connected electrically to the conductive pattern via dip soldering, the dip soldering performed using a dip soldering jig having an opening formed to expose only an area of the printed circuit board to be subjected to dip soldering, the method comprising at least a process for forming a gas venting hole to a portion on the printed circuit board in the area corresponding to the opening when the printed circuit board is attached to the dip soldering jig, dip soldering is carried out after forming the gas venting holes in the area of the opening formed to the dip soldering jig when the board is attached to the dip soldering jig, so that even when a dip soldering jig is used to perform soldering, the gases generated during the dip soldering process (gases generated by the volatilization of the flux) can be discharged through the gas venting holes and the occurrence of solder defects due to gases can be suppressed.

According to the second aspect of the present invention related to the method for manufacturing a printed circuit board according to the first aspect, wherein during the process for forming a gas venting hole to the printed circuit board, the gas venting hole is formed to an area adjacent to the electronic component subjected to dip soldering and on a side of the electronic component toward which the printed circuit board is fed during the dip soldering process, and wherein during the dip soldering process, the printed circuit board is fed along the feeding direction, the dip soldering process is performed with gas venting holes arranged on the front side of electronic components (in other words, placed higher than the components) subjected to dip soldering when the printed circuit board is fed to dip soldering with its front end raised with respect to the horizontal plane, the present method has superior performance to discharge gases generated during the dip soldering process. Since the solder jet stream output from the solder bath is quite hot, an ascending current is generated near the solder jet stream. Therefore, the gas venting holes formed on the front side of the electronic components which are placed higher than the components exert superior gas discharge performance.

According to the fifth aspect of the present invention related to the printed circuit board with a gas venting hole according to the third and fourth aspects, wherein the diameter of the gas venting hole is within the range of 0.8 mm through 3.0 mm, the board can exert an effective gas discharge function during the dip soldering process. “The diameter of the gas venting hole being 0.8 mm or higher” discloses a practical minimum value of the hole diameter with an effective gas discharge ability, since a smaller hole diameter deteriorates the gas discharge ability, and “the diameter of the gas venting hole being 3.0 mm or smaller” discloses a practical maximum value of the hole diameter, since a larger hole diameter will lead to the molten solder leaking out through the hole to the upper surface of the board (opposite side from the side subjected to soldering)

According to the sixth aspect of the present invention related to the printed circuit board with a gas venting hole, wherein the diameter of the gas venting hole is within the range of 1.0 mm through 2.0 mm, the board can exert a more effective gas discharge performance in the dip soldering process. “The diameter of the gas venting hole being 1.0 mm or higher and 2.0 mm or smaller” discloses a most preferable range of diameter size that exerts an effective gas discharge ability but prevents leak of molten solder.

### BRIEF DESCRIPTION OF THE DRAWINGS

FIG. 1 is a schematic view of a printed circuit board with a gas venting hole according to embodiment 1, wherein FIG. 1A is a perspective view and FIG. 1B is an upper view;

FIG. 2 is a perspective view showing the dip soldering jig;

FIG. 3 is a schematic view showing the state in which the printed circuit board with a gas venting hole is attached to the dip soldering jig, wherein FIG. 3A is a perspective view and FIG. 3B is a side view;

FIG. 4 is a perspective view showing in enlarged view a lead wire welding component 11a and a lead wire welding component 11b of the printed circuit board 10;

FIG. 5 is a perspective view showing the state in which the dip soldering is performed; and

FIG. 6 is a flowchart showing the outline of the portion of the present invention related to the method for manufacturing the printed circuit board according to embodiment 2.

### DETAILED DESCRIPTION OF THE PREFERRED EMBODIMENTS

Now, the preferred embodiments of the present invention will be described with reference to the drawings. The following embodiments are merely examples for practicing the present invention, and are not intended to limit the scope of the invention.

### Embodiment 1

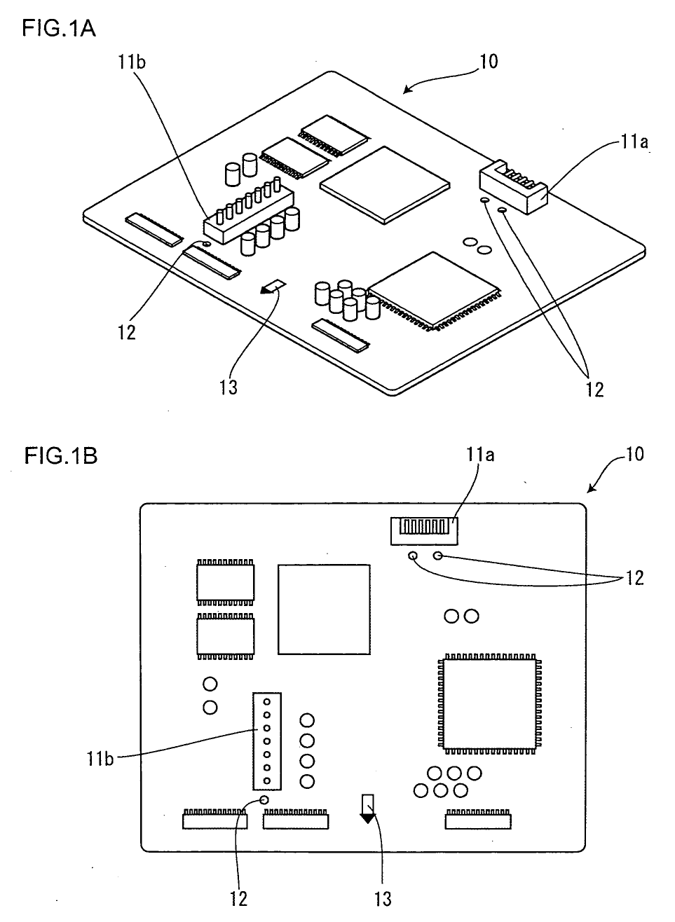

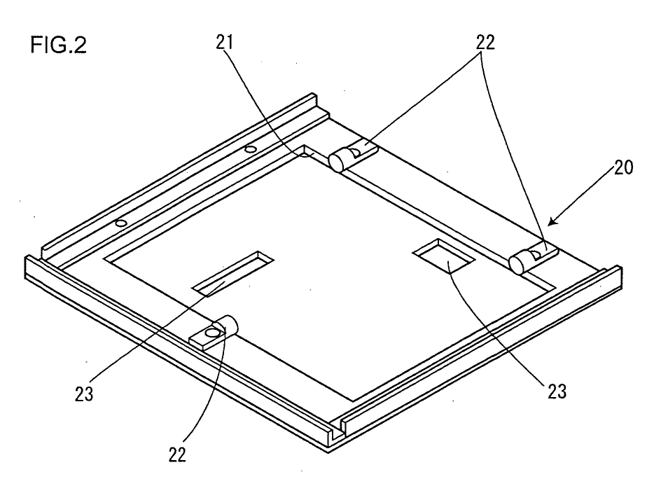

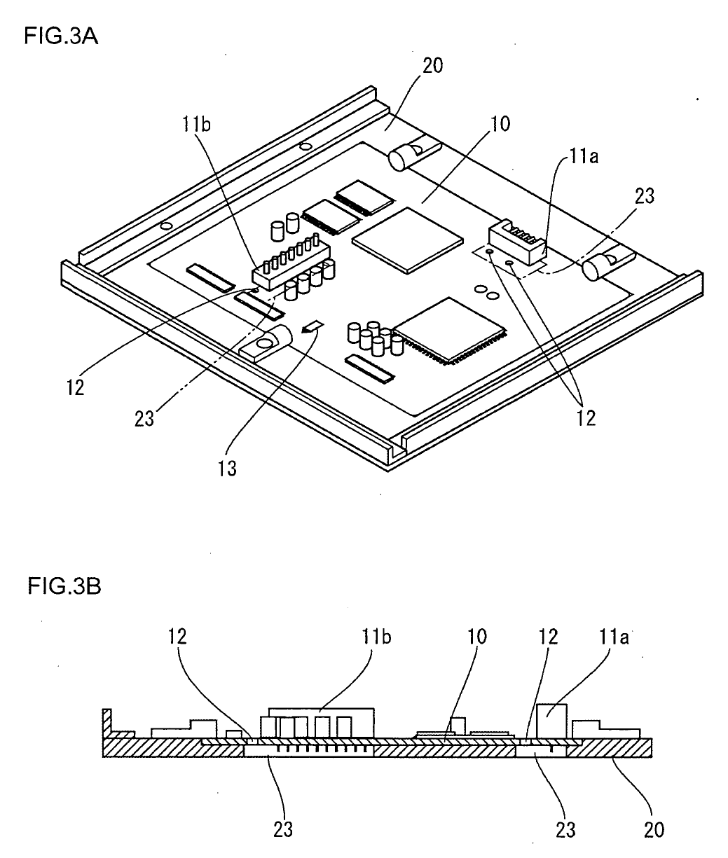

FIG. 1 is a perspective view showing the printed circuit board with a gas venting hole according to the present embodiment, wherein 1A is a perspective view and 1B is an upper view. FIG. 2 is a perspective view showing the dip soldering jig used in a dip soldering process. FIG. 3 is a schematic view showing the state in which the printed circuit board with a gas venting hole is attached to the dip soldering jig, wherein 3A is a perspective view and 3B is a cross-sectional concept view.

As illustrated in FIG. 1, a printed circuit board 10 includes electronic components (hereinafter called lead wire welding components) 11a and 11b wherein the electric connection to conductive patterns are performed via dip soldering, and has an arrow 13 showing the board feeding direction in the dip soldering process which is printed via serigraph. A dip soldering jig 20 comprises, as shown in FIG. 2, a recess 21, a stopper 22 and the like for positioning and stopping the printed circuit board 10, and has an opening 23 designed so that only the area of the printed circuit board 10 to be subjected to dip soldering (area where the lead wire welding components 11a and 11b are mounted) is exposed when the board 10 is attached thereto.

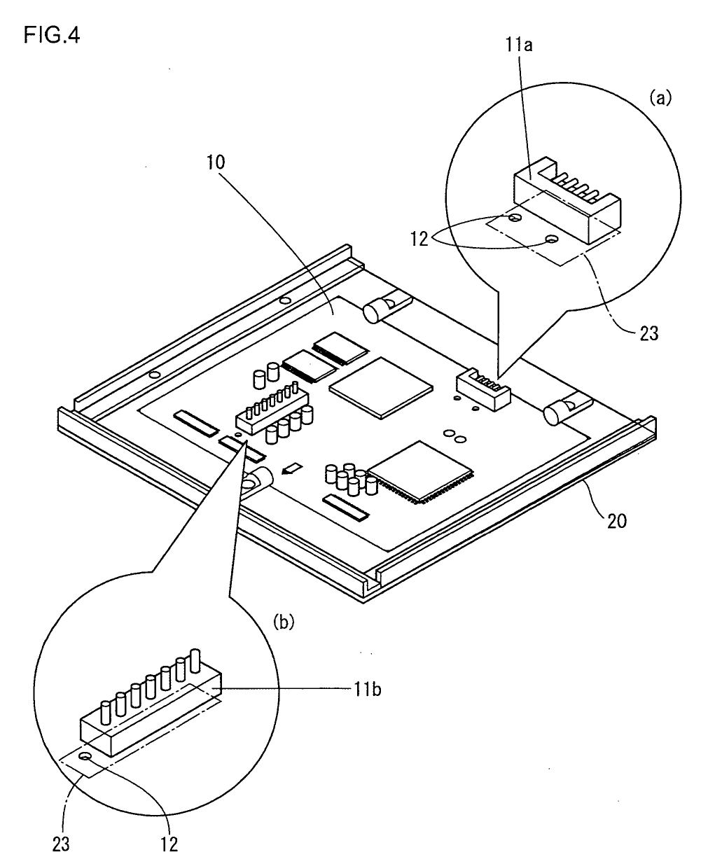

FIGS. 4(a) and (b) are perspective views showing in enlarged state the portions of lead wire welding components 11a and 11b of the printed circuit board 10. As illustrated in FIGS. 1, 3 and 4, the gas venting holes 12 are formed in areas adjacent to the lead wire welding components 11 on the side toward which the printed circuit board is fed during the dip soldering process, and within the area of the opening 23 on the dip soldering jig 20. The diameter of the gas venting hole 12 according to the present embodiment is 1.7 mm. Although not shown in the drawing, the printed circuit board 10 has various electric components mounted on both sides of a substrate to which a circuit pattern is printed, and various prints are provided thereto via serigraph.

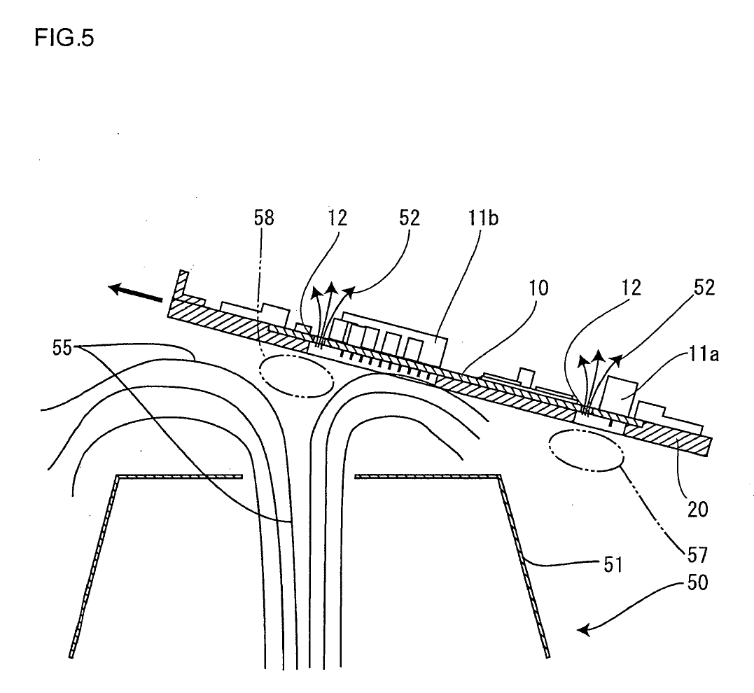

FIG. 5 is a perspective view showing the state in which the dip soldering is carried out. Molten solder 55 is jet-flown through a jet nozzle 51 provided to a solder bath 50. Lead wire welding components 11a and 11b are mounted on the printed circuit board 10 by dipping to the molten solder 55 the lower surface of the dip soldering jig 20 to which the printed circuit board 10 is attached (the surface of the circuit board 10 to which soldering is to be performed), and then cooling the same. As illustrated, when feeding the printed circuit board 10 to the solder bath 50, the front end of the board in the advancing direction is raised (tilted with respect to the horizontal plane) so as to prevent excessive solder from being attached and to enable proper soldering to be performed.

According to the printed circuit board 10 of the present invention, as shown in FIG. 5, the gas venting holes 12 are formed at positions higher than the areas to which the molten solder 55 is applied to the lead wire welding components 11a and 11b being soldered in the dip soldering process, so that gas 52 generated by the volatilization of the flux applied to the soldering surface of the printed circuit board can be released effectively. That is, since near the flowing molten solder 55 the heat from the molten solder generates an ascending current, the gas venting holes 12 formed to a higher position than the area of application of the molten solder 55 to the lead wire welding components 11a and 11b enable effective discharge of gases 52 generated at areas of the board 10 subjected to dip soldering (portions where the lead wire welding components 11a and 11b are mounted). Thus, it is possible to prevent solder defects caused by gases 52. According further to the present embodiment, the diameter of the gas venting holes 12 formed to the printed circuit board 10 is set to 1.7 mm, which enables both to prevent molten solder 55 from leaking through the gas venting holes 12 and to exert sufficient gas venting performance.

### Embodiment 2

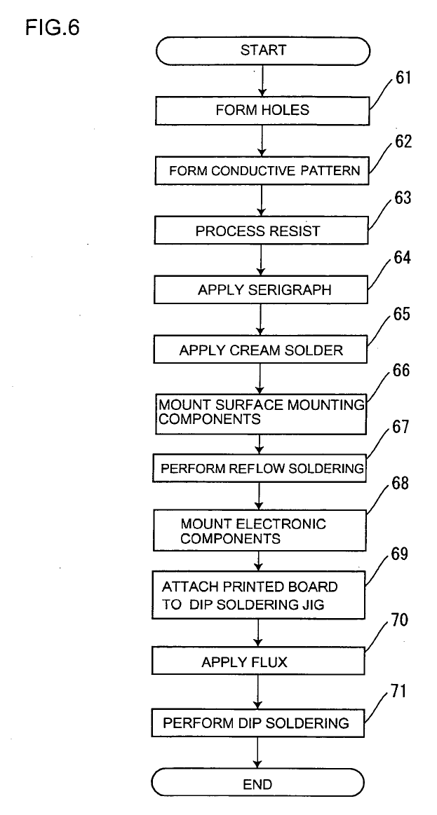

FIG. 6 is a flowchart showing the outline of the portion corresponding to the invention related to the method for manufacturing the printed circuit board of the present embodiment. The dip soldering jig used in the dip soldering process according to the present embodiment is the same as that of embodiment 1, and the printed circuit board being manufactured by the present embodiment is the same as that of embodiment 1. The same components are denoted with the same reference numbers, and detailed descriptions thereof are omitted.

The outline related to the present embodiment in the method of manufacturing the printed circuit board 10 will be described with reference to FIG. 6. The forming of gas venting holes 12 is simultaneously performed during a process for forming through holes etc. for mounting electronic components and through holes for engaging screws for fixing the substrate (step 61). As shown in FIGS. 1 and 4, the gas venting holes 12 are formed in areas adjacent to the lead wire welding components 11 on the side toward which the printed circuit board is fed during the dip soldering process (step 71), and within the areas of the openings 23 on the dip soldering jig 20. Next, conductive patterns constituting a part of the circuit on the printed circuit board 10 is formed through pattern printing and etching (step 62). After applying a solder resist so that soldering is performed only within necessary areas (step 62), an arrow 13 showing the feeding direction of the board in the dip soldering process is printed via serigraph together with instructions showing the variation and position of components to be mounted on the printed circuit board 10 (step 64). Next are the steps for soldering the components on the printed circuit board 10, wherein reflow soldering (steps 65 through 67) and dip soldering (steps 68 through 71) are carried out according to components.

The surface mounting components are soldered onto the printed circuit board 10 in the reflow soldering process, wherein a cream solder is applied for soldering the surface mounting components (step 65), on which the surface mounting components are placed (step 66), after which the board is sent to a heating furnace (step 67). Although not shown in the flowchart, surface mounting components are mounted on both sides of the printed circuit board 10 in the present embodiment, so both sides are subjected to reflow soldering. In the dip soldering process, lead wire welding components 11 are mounted to the printed circuit board 10 by having leads on the components 11 inserted to through holes formed (in step 61) on the printed circuit board 10 (step 68), then the printed circuit board 10 is fixed to the dip soldering jig 20 (step 69). Thereafter, flux is applied to the surface of the printed circuit board 10 being subjected to soldering (step 70), and then the board 10 is fed to the dip solder bath 50 so as to have the lead wire welding components 11 soldered to the printed circuit board 10 (step 71).

According to the method for manufacturing a printed circuit board of the present embodiment, the dip soldering process (step 71) is carried out after the process for forming the gas venting holes 12 (step 61), so that during the dip soldering process, the gases 52 generated by the volatilization of the flux can be discharged through the gas venting holes 12, by which the generation of soldering defects can be prevented. Furthermore, since the gas venting holes 12 are formed on the side of the lead wire welding components 11 toward which the board 10 is fed (board feeding direction 13 or forward in the traveling direction) in the dip soldering process (step 71), the gas venting holes 12 are positioned higher than where the molten solder 55 contacts the lead wire welding components 11a and 11b when the board 10 is fed in the feeding direction during the dip soldering process (step 71) illustrated in FIG. 5. Therefore, the present embodiment enables to effectively discharge gases 52 generated in dip soldering areas on the printed circuit board 10 (mounting areas of lead wire welding components 11a and 11b) in spaces 57 and 58 between the lower surface of the dip soldering jig 20 and the jet-flown molten solder 55.

In the present embodiment, the formation of the gas venting holes 12 is carried out in the same process (step 61) as the formation of the through holes for mounting electronic components and through holes for engaging the board fixing screws in order to reduce the manufacturing steps and improve work efficiency, but according to the present invention, the holes can be formed at any arbitrary timing prior to the dip soldering process (step 71).

1. A method for manufacturing a printed circuit board having a conductive pattern formed on an insulating board and an electronic component connected electrically to the conductive pattern via dip soldering, the dip soldering performed using a dip soldering jig having an opening formed to expose only an area of the printed circuit board to be subjected to dip soldering, the method comprising at least a process for forming a gas venting hole to a portion on the printed circuit board in the area corresponding to said opening when the printed circuit board is attached to the dip soldering jig, prior to the dip soldering process.

2. The method for manufacturing a printed circuit board according to claim 1, wherein during the process for forming a gas venting hole to the printed circuit board, the gas venting hole is formed in an area adjacent to the electronic component subjected to dip soldering and on a side of the electronic component toward which the printed circuit board is fed during the dip soldering process, and wherein during the dip soldering process, the printed circuit board is fed in said feeding direction.

3. A printed circuit board with a gas venting hole having a conductive pattern formed on an insulating board and an electronic component connected electrically to the conductive pattern via dip soldering, the dip soldering performed using a dip soldering jig having an opening formed to expose only an area of the printed circuit board to be subjected to dip soldering, the printed circuit board comprising a gas venting hole formed to a portion on the printed circuit board in the area corresponding to said opening when the printed circuit board is attached to the dip soldering jig.

4. The printed circuit board with a gas venting hole according to claim 3, wherein the gas venting hole is formed in an area adjacent to an electronic component subjected to dip soldering and on a side of the electronic component toward which the printed circuit board is fed during the dip soldering process.

5. The printed circuit board with a gas venting hole according to claim 3, wherein the diameter of the gas venting hole is within the range of 0.8 mm through 3.0 mm.

6. The printed circuit board with a gas venting hole according to claim 4, wherein the diameter of the gas venting hole is within the range of 0.8 mm through 3.0 mm.

7. The printed circuit board with a gas venting hole according to claim 5, wherein the diameter of the gas venting hole is within the range of 1.0 mm through 2.0 mm.

8. The printed circuit board with a gas venting hole according to claim 6, wherein the diameter of the gas venting hole is within the range of 1.0 mm through 2.0 mm.
